(19) United States
(12) Patent Application Publication
(10) Pub. No.: US 2026/0321018 A1
(43) Pub. Date: Oct. 15, 2026

(54) COMPUTER SYSTEM AND METHOD FOR MARITIME SURVEILLANCE AND SATELLITE-BASED EARTH OBSERVATION OF OBJECTS USING NADIR-NADIR IMAGE MATCHING

(71) Applicant: MDA Systems Ltd., Richmond (CA)

(72) Inventors: Adam SCHNEIDER, Vancouver (CA); Hans WEHN, Bowen Island (CA)

(21) Appl. No.: 19/482,077

(22) PCT Filed: Apr. 26, 2024
(86) PCT No.: PCT/CA2024/050558

§ 371 Date: Nov. 6, 2025

Related U.S. Application Data
(60) Provisional application No. 63/502,491, filed on May 16, 2023.

(51) Int. Cl. G06V 20/54; G06V 10/74; G06V 10/82; G06V 20/13

(52) U.S. Cl. CPC G06V 20/54; G06V 10/761; G06V 10/82; G06V 20/13

(57) ABSTRACT

Computer systems and methods for maritime surveillance and identification of unknown vessels are provided. The system includes at least one data storage device storing: a database of known optical nadir satellite images each containing a known candidate vessel having a known unique vessel identifier; and an unknown optical nadir satellite image containing an unknown vessel. The system also includes at least one processor configured to execute a nadir-nadir image matcher configured to: compare, via a neural network, the unknown nadir image to a plurality of known nadir images in the database, the comparing including determining a similarity score indicating a similarity level between the unknown nadir image and a respective known nadir image; output, via the neural network, a ranked list of the known nadir images based on the determined similarity scores; and assign a known unique vessel identifier to the unknown nadir image based on the ranked list.

### TECHNICAL FIELD

The following relates generally to maritime surveillance and satellite-based earth observation, and more particularly to systems and methods for maritime surveillance and satellite-based earth observation using computer vision and machine learning.

### INTRODUCTION

Although ground-based and aircraft platforms may be used, satellites provide a great deal of the remote sensing imagery commonly used today. Satellites have several unique characteristics which make them particularly useful for remote sensing of the Earth's surface. Approaches to performing such remote sensing includes using imaging techniques, such as high resolution optical imaging and synthetic aperture radar (“SAR”) imaging.

One particular domain in which satellite imaging is used is earth observation. Various problems in earth observation may benefit from satellite imaging. One such example is vessel detection (including the ability to detect non-transmitting dark ships, illegal fishing activity, etc.). More generally, it may also be desirable to track an object (e.g., a marine vessel) across multiple images or to confirm that an object present in one image is the same as a known object present in another image.

Overhead imagery (or nadir imagery), namely very-high-resolution (VHR) satellite optical imagery, can be an extremely valuable resource for the tasks of vessel detection, identification, and tracking. For vessel identification, satellite platforms such as WorldView (WV-2 and WV-3) offer unprecedented optical imaging capabilities, with spatial resolutions in the 30 to 60 cm range.

In some cases, available data may include optical near-nadir-looking satellite images containing known objects. The objects in such nadir images may be “known”, in the sense that a respective nadir image containing an object may be associated with a unique object identifier that identifies the object. It may be desirable to confirm an identity of an object in a new overhead or nadir satellite image using available nadir satellite images containing objects with known identity.

Accordingly, there is a need for an improved system and method for maritime surveillance and satellite-based earth observation that overcomes at least some of the disadvantages of existing systems and methods.

### SUMMARY

A computer system for computer vision-based maritime surveillance and identification of unknown vessels is provided. The system includes at least one data storage device storing: a database of known optical nadir satellite images each containing a known candidate vessel, each known candidate vessel having a known unique vessel identifier associated therewith that is stored in the database and which identifies the known candidate vessel; and an unknown optical nadir satellite image containing an unknown vessel. The system also includes at least one processor configured to execute a nadir-nadir image matcher, the nadir-nadir image matcher configured to: compare, via a neural network, the unknown nadir image to a plurality of known nadir images in the database, the comparing including determining a similarity score indicating a similarity level between the unknown nadir image and a respective known nadir image; output, via the neural network, a ranked list of the known nadir images, the ranked list based on the determined similarity scores, wherein a higher ranking in the ranked list indicates a higher similarity score and greater likelihood of the known vessel in the known nadir image being the same as the unknown vessel in the unknown nadir image; and assign a known unique vessel identifier to the unknown nadir image based on the ranked list.

The nadir-nadir image matcher may be further configured to store the unknown nadir image as a new known nadir image in the database, the database including the assigned known vessel identifier in association with the new unknown nadir image.

The at least one processor may be further configured to execute a user interface module configured to display a graphical user interface including a graphical representation of the ranked list and receive a user input selecting a known nadir image from the ranked list, and the assigning may include assigning, in response to the user input, the known vessel identifier associated with the selected known nadir image to the unknown nadir image.

The graphical representation of the ranked list may include, for each known nadir image in the ranked list, a visual representation of the known nadir image.

Assigning the known unique vessel identifier to the unknown nadir image may be performed automatically without user input by the nadir-nadir image matcher based on a similarity score of a known nadir image associated with the known unique vessel identifier exceeding a predetermined threshold similarity score.

The at least one processor may be further configured to execute a user interface module configured to: display a graphical user interface including the assignment of the known vessel identifier to the unknown nadir image and a visual representation the known nadir image associated with the known unique vessel identifier and the unknown nadir image; and receive a user input confirming or rejecting the assignment.

The unique vessel identifier may be a maritime mobile service identify number.

The neural network may be a Siamese neural network configured to receive a plurality of nadir image pairs as input, each nadir image pair including the unknown nadir image and a known nadir image from the database.

A trajectory comprising a time and location of the unknown vessel may be encoded with the unknown nadir image and used by the at least one processor to determine the plurality of known nadir images to which the unknown nadir image is compared by the nadir-nadir image matcher.

The plurality of known nadir images may represent a list of candidate vessels identified by a feasible vessel finder module based on a trajectory of unknown vessel in the unknown nadir image.

The at least one processor may be further configured to execute the feasible vessel finder module to obtain the list of candidate vessels.

The unknown nadir image may have only one time and location encoded therewith that is used to determine the plurality of known nadir images for comparison with the unknown nadir image via a trajectory analysis.

The trajectory may be obtained from automatic identification system (AIS) data.

A method of computer vision-based maritime surveillance and identification of unknown vessels is also provided. The method includes: comparing, via a neural network, a cropped unknown nadir image to at least one known nadir image of a known vessel stored in a nadir imagery database, the comparing including determining a similarity score indicating a similarity level between the cropped unknown nadir image and the compared known nadir image, the known nadir image containing a known candidate vessel having a known unique vessel identifier associated therewith that is stored in association with the known nadir image and which identifies the known candidate vessel; outputting, via the neural network, a ranked list of the known nadir images that were compared to the cropped unknown nadir image, the ranked list based on the determined similarity scores, wherein a higher ranking in the ranked list indicates a higher similarity score and greater likelihood of the known vessel in the known nadir image being the same as the unknown vessel in the unknown nadir image; and assigning at least one unique vessel identifier to the cropped unknown nadir image based on the ranked list.

The method may further include identifying a trajectory of the unknown vessel in the unknown nadir image and using the trajectory to identify a subset of the known nadir images in the nadir imagery database for comparison to the unknown nadir image.

A computer system for computer vision-based identification of unknown objects in optical nadir satellite images is provided. The system includes at least one data storage device storing: a database of known optical nadir satellite images each containing a known candidate object, each known candidate object having a known unique object identifier associated therewith that is stored in the database and which identifies the known candidate object; and an unknown optical nadir satellite image containing an unknown object. The system also includes at least one processor configured to execute a nadir-nadir image matcher, the nadir-nadir image matcher configured to: compare, via a neural network, the unknown nadir image to a plurality of known nadir images in the database, the comparing including determining a similarity score indicating a similarity level between the unknown nadir image and a respective known nadir image; output, via the neural network, a ranked list of the known nadir images, the ranked list based on the determined similarity scores, wherein a higher ranking in the ranked list indicates a higher similarity score and greater likelihood of the known object in the known nadir image being the same as the unknown object in the unknown nadir image; and assign a known unique vessel identifier to the unknown nadir image based on the ranked list.

A method of computer vision-based identification of unknown objects in optical nadir satellite images is also provided. The method includes: comparing, via a neural network, a cropped unknown nadir image to at least one known nadir image of a known object stored in a nadir imagery database, the comparing including determining a similarity score indicating a similarity level between the cropped unknown nadir image and the compared known nadir image, the known nadir image containing a known candidate object having a known unique object identifier associated therewith that is stored in association with the known nadir image and which identifies the known candidate object; outputting, via the neural network, a ranked list of the known nadir images that were compared to the cropped unknown nadir image, the ranked list based on the determined similarity scores, wherein a higher ranking in the ranked list indicates a higher similarity score and greater likelihood of the known object in the known nadir image being the same as the unknown object in the unknown nadir image; and assigning at least one unique object identifier to the cropped unknown nadir image based on the ranked list.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a computer system for vessel identification using optical nadir-nadir satellite image matching, according to an embodiment;

FIG. 2 is a schematic diagram of a Siamese network architecture for use in a nadir-nadir image matcher, according to an embodiment;

FIG. 3 is a graph plotting accuracies on a validation set for a network with a ResNet-50 backbone and a square resizing of the images, with overall accuracy in blue, class-specific accuracies (recall) for the positive and negative pairs in green and red, respectively, according to an embodiment;

FIG. 4 is graph plotting cumulative matching characteristic (CMC) curves of top-k accuracies for all k in [1, 2, . . . , 50] on the test set counting 515 vessels for four models, according to an embodiment;

FIG. 5 illustrates top-5 ranking results for model “square_resize” when asked to retrieve the most similar vessels to an image of vessel with MMSI 566339000, (a tanker), wherein the distance between probe image and each MMSI (average of all the distances to the current MMSI's images) is reported for each row and the correct MMSI is returned at rank 2 in this case, according to an embodiment:

FIG. 6 is a histogram of similarity scores for nadir-nadir images processed by a nadir-nadir image matching model, according to an embodiment;

FIG. 7 is a graph plotting PD and 1-PFa rates and precision, recall, and F1 scores versus threshold (top row) with PD versus PFa and precision versus recall (bottom row), for a nadir-nadir matcher, according to an embodiment;

FIG. 8 is a flow diagram of a method of object identification using nadir optical satellite images, according to an embodiment;

FIG. 9 is a block diagram of a computer system for vessel identification including a nadir-nadir image matcher, such as the nadir-nadir image matcher of FIG. 1, according to an embodiment; and

FIG. 10 is a schematic diagram of a computer system for object identification using nadir-nadir image matching, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to maritime surveillance and satellite-based earth observation, and more particularly to systems and methods for maritime surveillance and satellite-based earth observation using computer vision and machine learning.

The term “known nadir image” and its variants as used herein refers to a nadir or overhead image of or that contains a known object. A “known object” refers to an object (e.g., a vessel) in the image that has been identified and assigned a unique identifier (e.g., a MMSI number), which is stored in association with the “known nadir image”. Accordingly, a “known nadir image” may be considered “a nadir image of a known object”. The term “unknown nadir image” and its variants as used herein refers to a nadir or overhead image of or that contains an unknown object. An “unknown object” refers to an object (e.g., a vessel) in the image that has not yet been identified and assigned a unique identifier (e.g., a MMSI number), which is stored in association with the “unknown nadir image”. Accordingly, an “unknown nadir image” may be considered “a nadir image of an unknown object”. For both unknown and known nadir images, the source of the images (i.e., where they came from) and the time and allocation of the area in the respective image are known.

While many of the embodiments described herein are directed to marine vessel identification, it is to be understood that the systems and methods of the present disclosure may be used, in variations, to perform identification of other types of objects though nadir-nadir image matching and the applications of the systems and methods of the present disclosure are not limited to vessel detection. Thus, it is understood that reference in the present disclosure to “vessel” or “vessel detection” is merely one example and is meant to include any type of object suitable for nadir-nadir image matching as described herein.

The present disclosure provides systems and methods for tackling the vessel identification problem based on image sources using state-of-the-art machine learning and computer vision approaches from the sub-field of one-shot/low-shot image recognition.

Vessel identification as used herein and as performed using the systems and methods of the present disclosure may refer to vessel identification in absolute terms with the retrieval of an absolute identity (e.g., MMSI number or other unique vessel identifier) of the vessel of interest (e.g., from a large database of images). This may occur, for example, where a system operator is interested in inspecting a few vessels appearing in a given image, to check for their identity/characteristics from an existing vessel database.

Vessel identification as used herein and as performed using the systems and methods of the present disclosure may refer to vessel identification in relative terms by re-identifying a given vessel among a reduced list of candidates. In this case, the vessel identification may be used to uniquely re-identify the same vessel across multiple images, supporting the task of vessel tracking. This may happen at a short temporal scale, for example, where multiple images are acquired within a few hours along a maritime corridor where ships have to be re-identified and matched across acquisitions. A similar approach may be applied at a larger temporal and spatial window, for instance in the case of the search and tracking of a suspicious vessel that might have visited multiple ports or entered a monitored zone (vessel on a “watch list”), days or even months apart.

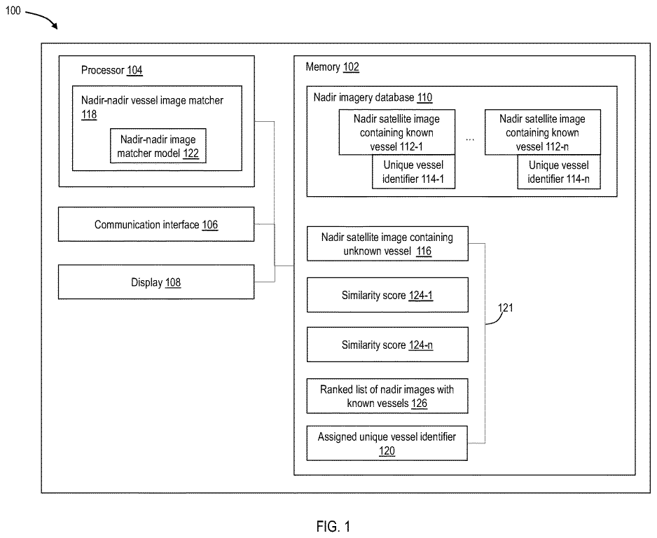

Referring now to FIG. 1, shown therein is a system 100 for vessel identification using nadir-nadir image matching, according to an embodiment.

In an embodiment, the system 100 uses optical satellite images to identify dark vessels by matching a new near-nadir satellite image to a database of near-nadir satellite imagery of known vessel candidates. Generally, the system 100 can be used to determine if a vessel in a first nadir satellite image (which may be a cropped nadir image) is the same vessel as one seen in a second nadir satellite image (which may be a cropped nadir image).

The system, or a subset of components thereof, may be implemented as part of a larger vessel identification system (e.g., a platform to aid in dark vessel detection). For example, in an embodiment, the system 100 may be implemented along with one or more of a nadir-oblique image matcher and a SAR-SAR image matcher, where the outputs of multiple models each directed to different image source pairs are further processed to perform vessel identification.

The system 100 may include one or more computer devices. For example, the system 100 may include a plurality of computer devices in communication via a network connection. Further, components of the system 100 may be implemented at a single computer device, or across a plurality of computer devices.

In some embodiments, the system 100 includes at least one user computing device and at least one server computing device in communication via a network connection. The user device may execute an application that can interact with server-side software components (“services”) hosted by the server computing device. For example, the computer system 100 may execute a network-based software application that executes partially at the server computing device (via server-side software components) and partially at the user device (via client-side software components). In an embodiment, the client-side software components include a user interface (e.g., web-based user interface).

The system 100 includes a memory 102 and a processor 104 in communication with the memory 102.

The system 100 includes a communication interface 106 for transmitting and receiving data. The communication interface 106 may include a network interface.

The system 100 includes a display 108 for displaying data generated by the system 100. The display 108 may be located at a user device of the system 100.

The memory 102 stores a database 110 of known nadir satellite images (also referred to as “nadir imagery database”). Each known nadir image in the database 110 contains a vessel. The known nadir image is an optical satellite image. The known nadir may be a high resolution satellite image. The known nadir image may have been acquired by an earth observation satellite.

The database 110 also stores a unique vessel identifier for each known nadir image. The unique vessel identifier identifies the vessel represented in the known nadir image. In an embodiment, the unique vessel identifier is a maritime mobile service identify (“MMSI”) number. The unique vessel identifier is stored in the database 110 such that the unique vessel identifier is associated with (and thus retrievable based on) the known nadir image.

For illustrative purposes, database 110 in FIG. 1 is shown to include known nadir satellite image 112-1 and known nadir satellite image 112-n. In variations, any suitable number of nadir satellite images may be stored in the database 110 and used. The database 110 also stores unique vessel identifier 114-1 and unique vessel identifier 114-n, which are associated with known nadir images 112-1 and 114-n, respectively. Known nadir images 112-1 and 112-n may be referred to collectively as known nadir images 112 and generically as known nadir image 112.

Given that each known nadir image in the database 110 has an associated unique vessel identifier identifying the vessel in the known nadir image, such vessel is considered “known” (i.e., a “known vessel” or “known vessel candidate”, as its identity is known).

The memory 102 also stores a new nadir satellite image 116. The new nadir image 116 contains an unknown vessel (also referred to as a “vessel of interest”). That is, the new nadir image 116 contains a vessel whose identity is unknown and for which a user wants to determine or confirm an identity. Memory 102 may store a plurality of new known nadir images 116 that are to be processed by the system 100. In some cases, the new nadir image 116 may be a plurality of images of the same vessel.

The new nadir image 116 may contain a suspicious dark vessel (“vessel of interest” or “unknown vessel”) whose trajectory has been identified. The trajectory may be represented by the time and location of a detection. The time and location of a new nadir image are used to select which known vessel images to put in a candidate list. The candidate list includes a set of known nadir images that are compared (matched) to the unknown nadir image by the nadir-nadir image matcher. The candidate list may be selected or determined by a feasible ship finder module or component. The time and location of the new nadir image may be encoded with the image. The time and location may be encoded by the satellite that captured the image. A trajectory of two or more detections can be formed by associating multiple detections with each other due to the proximity of their locations at the times of detection, combined with other characteristics of the detections such as object size or velocity. The feasible ship finder component identifies whether two detections could possibly belong to the same trajectory or not and removes candidate vessels (e.g., in a database of known nadir images) from the candidate list that could not possibly be the same object due to their last known location. In some embodiments, the trajectory of an unknown nadir image is only required to have one time/location. The enables the feasible ship finder to provide a sufficiently short candidate list, which may avoid a scenario where every existing ship is a candidate. Trajectory may correspond to or be obtained from trajectory data. The trajectory data may be automatic ship identification system (“AIS”). The automatic identification system (AIS) is an automatic tracking system that uses transceivers on ships and is used by vessel traffic services.

In some cases, the new nadir vessel image 116 is a cropped new nadir vessel image. For example, an optical nadir satellite image may be processed to detect a vessel of interest in the image. This may be performed, for example, by providing the optical nadir satellite image as input to an object detection model trained to detect one or more classes of vessels of interest in the input image. Detecting may include localizing the vessel in the image (e.g., via a bounding box) and assigning a class label to the vessel. In some cases, a confidence level may also be determined and provided. In some embodiments, the system 100 may include an object detection model for performing vessel detection in nadir satellite images. An annotated version of the nadir satellite image (e.g., annotated with object location/bounding box data) may then be provided as input to a cropping module configured to crop the detected vessel out of the nadir satellite image. In some embodiments, the cropping module may be a component of system 100, for example executed by processor 104. The cropping module generates a cropped new nadir vessel image that includes the detected vessel of interest. In cases where multiple vessels have been detected in an image, a corresponding number of cropped nadir images may be generated.

The processor 104 includes a nadir-nadir vessel image matcher 118. The nadir-nadir vessel image matcher 118 may also be referred to as an overhead-overhead image matcher 118 (or simply “image matcher 118”). The nadir-nadir image matcher 118 compares nadir images of potentially the same object).

The nadir-nadir vessel image matcher 118 determines if the vessel in the new nadir vessel image 116 is the same vessel as a vessel contained in a similar known nadir vessel image 112.

The nadir-nadir image matcher 118 is configured to determine a specific identity of the unknown vessel in the new nadir image 116 based on known identities of vessels in the database 110 (i.e., in the known nadir images 112). The determined specific identity of the unknown vessel in the new nadir image 116 is represented in the system 100 as an assigned unique vessel identifier 120. The format of the assigned unique vessel identifier 120 is the same as the unique vessel identifiers 114 associated with the known nadir images 112. In an embodiment, the assigned unique vessel identifier 120 is an MMSI number. Generally, the nadir-nadir image matcher 118 may determine and assign the unique vessel identifier 120 to the new nadir image 116 based on a comparison of the new nadir image 116 to one or more known nadir images 112 in the database 110. In FIG. 1, new nadir satellite image 116 has been assigned unique identifier 120, wherein the unique identifier 120 identifies the vessel contained in the nadir image 116. The assigned unique identifier 120 is stored in the database 110 such that the assigned unique identifier 120 is associated with the new nadir satellite image 116 (and thus, with the vessel contained in the image 116) and can be retrieved using the new nadir satellite image 116.

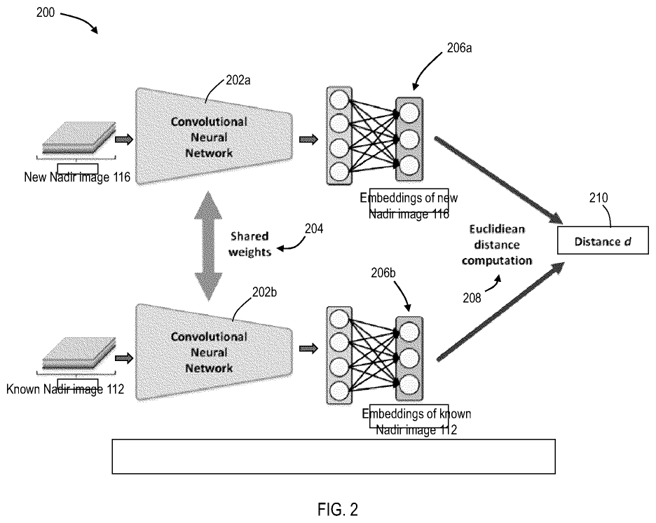

The nadir-nadir image matcher 118 includes a nadir-nadir image matcher model 122 (also referred to as a “neural network” or “neural network model”). The nadir-nadir image matcher model 122 includes an encoder (in some cases, such as shown in FIG. 2, one encoder with two identical copies) for generating compressed feature vectors representing salient and useful features for matching with those in other nadir images. In some embodiments, multiple encoders trained in the same way may be used and their respective output encodings averaged as a form of ensembling.

By using such an approach instead of storing high resolution images in a database, the image matcher 118 may improve storage and efficiency. For example, high resolution images may be stored somewhere, but such images use a lot of space and searching through those images can be a slow process. In the system 100, the high resolution images are only used to train the encoders. Once training of the encoders is finished, the encoders convert the images into compressed feature vectors. The compressed feature vectors use far less space for storage and can be retrieved for comparison and searching much faster. The encoders are optimized (via training) to retain only the necessary information in the feature vectors to decide if their corresponding high resolution images match.

The image matcher model 122 includes a neural network. The neural network may include a Siamese neural network model. The model 122 is configured to receive a plurality of nadir image pairs as input, where each nadir image pair includes the new nadir satellite image 116 and a known nadir image 112 from the database 110. The image matcher model 122 compares the nadir images 116, 112 in the image pair to determine similarity. From the similarity determination, the image matcher model 122 determines whether the vessel in the new nadir image 116 is the same vessel in the known nadir image 112. If the vessel is determined to be the same, the image matcher model 122 (or image matcher 118) may assign or otherwise associate the unique vessel identifier 114 of the known nadir image 112 with the new nadir image 116. For example, if it the image matcher model 122 determines that new nadir image 116 is sufficiently similar to known nadir image 112-1 (e.g., by determining that a similarity level between the images meets a predefined threshold), the image matcher 118 may assign unique vessel identifier 114-1 to the new nadir image 116 as assigned unique vessel identifier 120. In such a case, the new nadir image 116 and assigned unique vessel identifier 120 may subsequently be stored in the database 110 as a known nadir image (i.e., for subsequent comparison with other new nadir images).

The image matcher model 122 compares the images 116, 112 in the image pair to determine similarity. The image matcher model 122 outputs a ranked list 124 of known vessels in the database 110 (i.e., represented in a known nadir image and having a unique vessel identifier associated therewith), the known vessels represented at least in part by their respective unique vessel identifier 114. The ranked list indicates which of the known vessels are most likely the unknown vessel in the unknown nadir image 116. The ranked list 126 may include only a subset of the known nadir images 112 in the database. For example, the ranked list 126 may include only those known nadir images 112 that meet a certain predetermined similarity threshold for inclusion in the ranked list 126.

Generally, the ranked list 126 may be configured such that a higher ranking in the list indicates a greater likelihood than a lower ranking that the known vessel (in the corresponding known nadir image 112) is the same as the unknown vessel in the unknown nadir image 116 (and thus should be assigned the same unique vessel identifier).

The nadir-nadir image matcher 118 receives as input an overhead satellite image 116 of a first vessel and a known overhead image of a second vessel (each known and unknown overhead/nadir image pair may be referred to as a nadir/overhead-nadir image pair or image pair). For each image pair compared, the nadir-nadir image matcher 118 processes the unknown nadir satellite image 116 and the known nadir image 112 and returns a similarity score between 0 and 1 indicating how well the unknown nadir satellite image 116 and the known nadir image 112 match. The similarity score may then be translated into a determination that the compared image pair is a match (matching pair) or non-match (non-matching pair). If the pair is a match, the image matcher 118 may assign the unique vessel identifier of the matching known nadir image 112 to the unknown nadir image 116 as the assigned unique vessel identifier 120 and store the association in memory 102.

For example, the image matcher 118 feeds unknown nadir satellite image 116 and known nadir image 112-1 to the image matcher model 122. The image matcher model 122 compares the images 116, 112-1 and outputs a similarity score 124-1 between 0 and 1 indicating how well the images 116, 112-1 match. For example, a score closer to 1 may indicate a higher likelihood of a match, while a score closer to 0 may indicate a lower likelihood of a match. The image matcher 118 then feeds unknown nadir satellite image 116 and known nadir image 112-n to the image matcher model 122. The image matcher model 122 compares the images 116, 112-n and outputs a similarity score 124-n between 0 and 1 indicating how well the images 116, 112-1 match.

Similarity scores 124-1, 124-n are referred to collectively as similarity scores 124 and generically as similarity score 124.

In some cases, the image matcher model 122 may implement a match threshold similarity score. The match threshold similarity score is a similarity score which, if reached, is considered a “match”. The match threshold similarity score is stored in memory 102. The image matcher model 122 or image matcher 118 compares the similarity scores 124 to the match threshold similarity score to determine whether the known nadir image 112 is a match (i.e., if the similarity score reaches the threshold, the vessel in the known nadir image 112 is considered to match the vessel in the unknown nadir image 116). Upon detecting a match, the image matcher 118 may automatically assign the unique vessel identifier 114 of the matching known nadir image to the unknown nadir image 116 as the assigned unique vessel identifier 120. Matches may be displayed to a user via a user interface. The match threshold similarity score may be set by a user, for example via a user interface of the system 100.

In some cases, the nadir-nadir image matcher 118 is configured to output, using a neural network (e.g., image matcher model 122), a ranked list of vessels 126 represented in known nadir images 112 in the nadir imagery database 110 that have known MMSI numbers (or other unique vessel identifier). The ranked list 126 indicates which of the vessels in the nadir imagery database 110 are most likely the same vessel detected in the unknown nadir satellite image 116. For example, image pairs 116, 112 processed by the nadir-nadir image matcher 118 with a higher similarity score 124 (as determined by the image matcher model 122) may cause the known nadir image 112 in the respective image pair (and, more particularly, the known vessel represented in the known nadir image) to be ranked higher on the ranked list 126 than a known nadir image 112 of an image pair with a lower similarity score 124. For example, the ranked list 126 may include known nadir images 112 in the nadir imagery database 110 ranked from highest similarity score to lowest similarity score as determined by the nadir-nadir image matcher model 122. In some cases, a threshold may be implemented whereby only those nadir images with a similarity score 124 above a certain predefined similarity threshold are included in the ranked list 126.

An example Siamese network architecture that may be implemented by network 122, according to an embodiment, is shown in FIG. 2.

Referring now to FIG. 2, shown therein is a Siamese network 200 that may be implemented by the nadir-nadir image matcher 118 for determining whether a first nadir image and second (known) nadir image match, according to an embodiment. The Siamese network 200 may be implemented as a component of the image matcher model 122 of FIG. 1.

Generally, the Siamese network 200 is an artificial neural network that uses the same weights while working in tandem on two different input vectors to compute comparable output vectors. In some cases, one of the output vectors may be precomputed (e.g., an output vector generated from known nadir image 112), which forms a baseline against which the other output vector (e.g., an output vector generated from new nadir satellite image 116) is compared.

The Siamese network 200 includes convolutional neural networks (CNNs) 202a, 202b. The CNNs 202a, 202b have shared weights 204. The CNNs 202a, 202b may be the same CNN, or separate instances of a CNN having shared weights. It should be noted that, in variations, unknown nadir image 116 and known nadir image 112 may be processed by the network 200 at the same time (or roughly the same time) or at different times (e.g., if known nadir image 112 is processed ahead of time and the output compared to an output generated from the unknown nadir image 116 when processed).

The CNN 202a generates embeddings 206a of the unknown nadir image 116. The CNN 202b generates embeddings 206b of the known nadir image 112. The embeddings 206a, 206b may be stored in memory 102.

The network 200 compares the embeddings 206a, 206b by executing a Euclidian distance computation 208 using the embeddings 206a, 206b as input to obtain a Euclidian distance output ‘d’ 210. The distance d 210 may be stored in memory 102. The distance d is used in the same way as the similarity score, with the distance d and similarity score having an inverse relationship. The larger the distance between two embeddings, the less likely they match, and the smaller the distance, the more likely they match.

Referring again to FIG. 1, the nadir-nadir image matcher 118 may be configured to store the unknown nadir image 110 as a new known nadir image in the database 110, where the database 110 includes the assigned known vessel identifier in association with the new unknown nadir image (now a known nadir image).

In some embodiments, the system 100 may configured to execute a user interface module configured to display a graphical user interface including a graphical representation of the ranked list 126 and receive a user input selecting a known nadir image from the ranked list 126. The assigning of the identifier may include assigning, in response to the user input, the known vessel identifier associated with the selected known nadir image to the unknown nadir image 110. The graphical representation of the ranked list 126 may include, for each known nadir image in the ranked list, a visual representation of the known nadir image.

In some embodiments, assigning the known unique vessel identifier to the unknown nadir image 110 may be performed automatically without user input by the nadir-nadir image matcher 118 based on the similarity score of a known nadir image associated with the known unique vessel identifier exceeding a predetermined threshold similarity score. In some embodiments, the system 100 may be configured to execute a user interface module configured to display a graphical user interface including the automatic assignment of the known vessel identifier to the unknown nadir image and a visual representation the known nadir image associated with the known unique vessel identifier and the unknown nadir image; and receive a user input confirming or rejecting the assignment.

A particular example embodiment of the image matcher model 122 comprising a Siamese neural network will now be described. The Siamese neural network model is configured to (re-)identify ships from a real-world maritime vessel dataset acquired by satellite (e.g., the WV satellites). The network 122 is trained to return a meaningful ranked list 126 of the most similar vessel images in database 110 when provided an input image for a specific vessel.

Following the Siamese neural network approach to deep metric learning, a network 122 was built that includes two encoder branches (first and second encoders) with a CNN backbone (e.g., ResNet). The encoder branches with CNN backbone are followed by a “global average pooling” layer (to be independent of the input image size) and by a series of fully-connected layers that output a feature vector of dimension n for each image (the embeddings or embedding vectors; first and second embedding vectors corresponding to first and second images). Two images (e.g., nadir image 116 and known nadir image 112) are input in parallel to the network 122 and go through the same operations, as the weights of the first and second encoders are shared. The network model 122 calculates the Euclidian distance d between the first and second embedding vectors. The model 122 uses the determined Euclidian distance is to determine if the two images 116, 112 in the pair are of the same individual object (positive sample, or “match”) or are representing two different objects (negative sample, or “non-match”).

To train the network 122, a loss function may be used. Example loss functions include: the contrastive loss:

$$\frac{⊥}{2} {{d}_{p}}^{2} + \frac{⊥}{2} {\{ max ( 0 , m - {d}_{n} ) \}}^{2}$$

or the triplet loss function:

ma(0,dp−dn+m)

where dp is the distance between images in the positive pair, dn in the negative pair, and m is a margin value.

This optimization results in minimizing the distance within positive pairs (matches) and maximizing the distance within the negative pairs (non-matches). The margin has the effect of reducing the importance of very dissimilar pairs (distance score beyond the margin) during the training procedure. When training the network 122, the network 122 is presented with three images: an anchor image, another image of the same vessel (positive pair), and an image of a different vessel (negative pair).

### Experimental Setup and Training

In an example, a WV dataset (shown in Table 2, below) was used including a total of 2575 unique vessels appearing twice or more across different scenes (3.1 occurrences on average). These repeated vessels were split into a training (70%), validation (10%) and test (20%) sets. A set was also added of 9169 ship occurrences from ships appearing only once across the entire set of images to be able to build a more diverse set of negative pairs (different ships) at training time for the network 122.

To ensure the model 122 learned from useful pairs only, the negative pair was formed only with images whose diagonal (a proxy for vessel length) is within 30% of the anchor image diagonal. In constructing the negative pair, to ensure diversity, vessels with single image occurrences were used 50% percent of the time. An embedding size n=100 was adopted. In these experiments, the contrastive loss function was used with a margin value m of 5 and a threshold set at 2.5 (positive pair if distance d<threshold). Various image augmentations were applied during the training including random changes to image brightness and contrast, horizontal and vertical flips, 360° rotations, and slight re-scaling of the images.

Experiments were conducted involving three backbone architectures (with pre-trained weights from ImageNet) and two image resizing strategies. As backbone CNNs, ResNet-50, EfficientNet-B4 and EfficientNet-B6 were tested. Before being fed to the network, the input images were either resized to a square of 500×500 pixels or to a rectangle of equal area (aspect-ratio taken as the median in the training set) rotated to have the major-axis horizontally aligned.

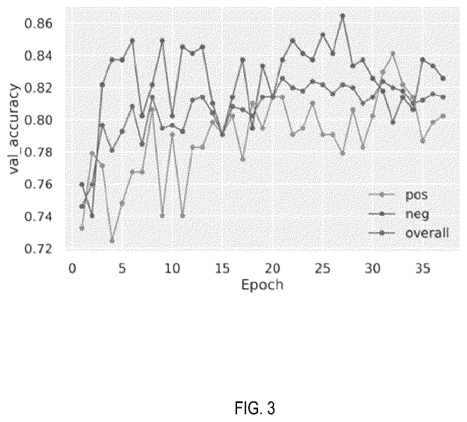

The validation set was used to select the best model based on the overall accuracy in the binary classification of the pairs based on the distance threshold. Referring now to FIG. 3 shows an example of the improvement in validation accuracy over the training epochs for the ResNet-50 backbone with a square resizing of the images. In this case, the best model is obtained at epoch 21 with a binary validation accuracy of 82.5%.

Model assessment in a real-world re-identification scenario will now be described.

Models were evaluated by using the independent test set of 515 vessels (each vessel with two or more image occurrences) by setting up a realistic vessel re-identification scenario. Starting from a Vessel of Interest (VOI, or “probe” vessel) observed or detected in given large-scale remote sensing acquisition (one image occurrence for a test set vessel), the model's capability was assessed in returning a ranked list of relevant results from a set of previously observed vessels available in a database (the “gallery” of all the other test set vessels; for example, database 110). The following procedure was applied:

First, for each individual image in the test set (across all vessels): (a) Set the vessel of the current image as VOI; (b) Select all the other available images for this VOI (previous “looks” for the VOI), excluding the original one; (c) Select all images of the other vessels in the test set with the condition that their length is within 30% of the original image (this represents the candidate ships in the database, each with a series of previous “looks”); (d) Obtain the embeddings for the original image of the current VOI and all images selected in step (b) and (c); (e) Compute the average Euclidean distance between the original image and each vessel (average of the distances to all image occurrences for a given vessel); and (f) Sort these distances from smallest to largest and compute the rank of the VOI among all candidates (ideally the VOI should rank first).

Second, based on the retrieved ranks for each individual image in the test set, compute the overall metrics.

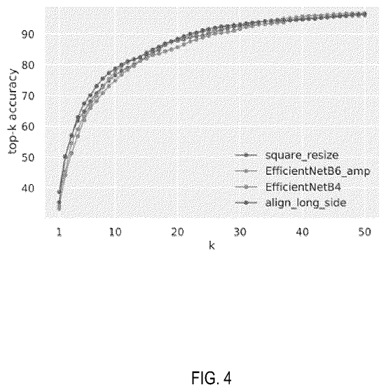

FIG. 4 depicts the Cumulative Matching Characteristic (CMC) curves (top-k accuracy metric for various values of k) for 4 models: (i) square_resize: ResNet-50 backbone, square images; (ii) EfficientNetB6_amp: EfficientNet-B6 backbone, square images (trained with automatic mixed precision); (iii) EfficientNetB4: EfficientNet-B6 backbone, square images; and (iv) align_long_side: ResNet-50 backbone, rectangular images aligned along their major axis.

The models showed very promising retrieval performances, with a top-1 accuracy as high as 38.7% and a median rank of 2 for the ResNet-50 model with a square resizing of the images (“square_resize”). Aligning the images while leaving them in their original rectangular shape seems to improve results when k is between 5 and 15, while using the more sophisticated EfficientNet does not seem to provide concrete performance benefits. The best top-10 accuracy of 78.7% (for “align_long_side”) indicates that the correct vessel was returned within the first 10 positions in close to ⅘ of the cases. We note how the prior knowledge on the vessel dimensions helps in narrowing down the list of candidates from 515 to 108 (median number), based on which the Siamese neural network creates the final ranking.

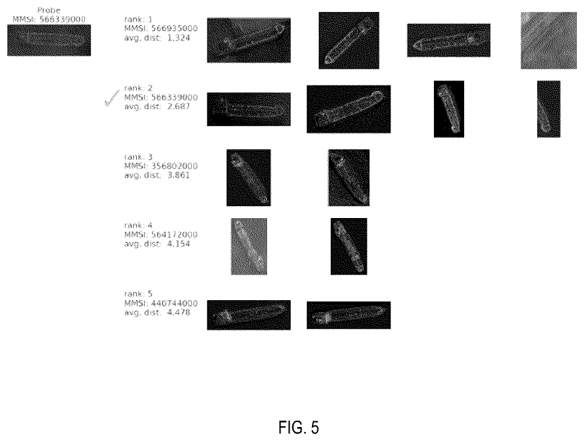

Referring now to FIG. 5, shown therein are the vessel re-identification results for tanker of the test set, according to an embodiment. The correct MMSI in the gallery for the probe image at hand is returned at rank number 2, indicating a good retrieval performance. We note how the task is very challenging even for a human operator, as all the candidates returned here are in fact tankers with very similar shapes/appearances.

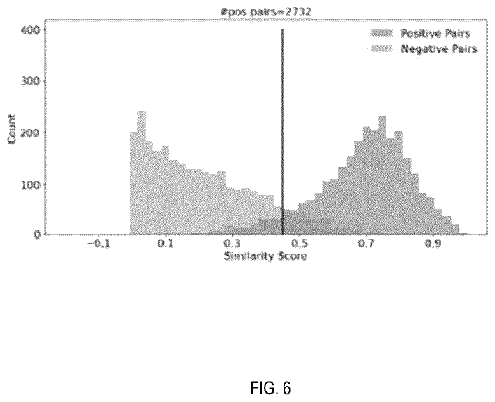

FIG. 6-4 Top-5 ranking results for model “square_resize” when asked to retrieve the most similar vessels to an image of vessel with MMSI 566339000, a tanker. The distance between probe image and each MMSI (average of all the distances to the current MMSI's images) is reported for each row. The correct MMSI is returned at rank 2 in this case.

Further upgrades, configurations, and experiments run with a Siamese neural network as image matcher model 122, according to embodiments, will now be described.

In an embodiment, a recently proposed loss function called Normalized Temperature-scaled Cross-Entropy (NT-Xent) is implemented. For a positive pair of images (i, j) in a batch of size N, it is defined as follows:

$$\text{?}$$

$$\text{?} \text{indicates text missing or illegible when filed}$$

where z is the embedding vector and T is a temperature parameter (set to 0.1).

This loss does not require sampling negative examples explicitly (images of different ships). Instead, for a given a positive pair, it treats the other 2(N−1) examples within a minibatch as negative examples. This optimization encourages the use of a large batch-size to increase the number of comparisons in the loss function.

Loss function experiments, according to embodiments, will now be described. A V1 dataset that included a total of 2575 unique vessels appearing twice or more across different scenes was used to test if this new loss function provides an improvement over the previously used contrastive loss. The same split into training (70%), validation (10%) and test (20%) sets was used.

In both cases, an image size of 600×600 pixels was used, aligned the images along their major axis, and considered and used a ResNet-50 as the backbone.

For the NT-Xent loss experiment, a large batch size of 42 was used. After experimenting with different temperature values, it was found that the default value of 0.1 yielded the best results.

On the independent test set of 515 vessels (each vessel with two or more image occurrences), the following vessel re-identification scenario was used: computing the average Euclidean distance between the probe image and each other candidate vessel (average of the distances to all image occurrences for a given vessel) and then ranking the candidates. This procedure only considered images whose diagonal (a proxy for vessel length) is within 30% of the probe image diagonal.

A notable improvement offered by the novel batch-based loss function was observed, with top-k accuracies consistently higher than those for the contrastive loss, for all k.

The contrastive loss obtained a top-1% accuracy of 64.8% while NT-Xent scored a superior 75.7%.

Filtered dataset and binary classification experiments, according to embodiments, will now be described.

Table 1 below shows the results of a Siamese model trained with the NT-Xent loss when using the 3 different datasets described in Table 2:

TABLE 1

| Dataset Name | length threshold | Number of unique MMSI |
|---|---|---|
| “WV MARCO | — | 9611 (of which 6001 in common with |
| POLO” V1 | | the “oblique” images dataset) |
| V2 | 40% | 9168 (of which 5650 in common with |
| | | the “oblique” images dataset) |
| V3 | 30% | 8981 (of which 5505 in common with |
| | | the “oblique” images dataset) |

TABLE 2

| | Length | Nr nadir | | | | | |
|---|---|---|---|---|---|---|---|
| | thres- | unique | Top- | F1 | | | |
| Dataser | hold | MMSIs | 1% acc. | score | PD | PFa | Pr |
| V1 | — | 9611 | 72.93% | 0.943 | 0.967 | 0.084 | 0.920 |
| V2 | 40% | 9168 | 72.58% | 0.932 | 0.915 | 0.047 | 0.951 |

The metrics refer to the performance on the test set (20% of the available MMSIs in each dataset). In these experiments, the length was not used as criterion for reducing the candidates in the ranking-based assessment.

Looking at the top-1% accuracy column, we first notice how, expectedly, not using the length criterion reduces the performance a bit (72.93% vs 75.7% reported in the previous section).

It can be observed how the increasingly clean datasets did not result here in an improvement of the ranking performance. Indeed, on the most aggressively filtered dataset (V3, with 30% threshold), the top-1% accuracy is decreased to 68.14%.

These seemingly contradictory results can be explained by the fact that all three sets (training, validation and test) have been cleaned, resulting thus both in an easier learning on the training set but also in a more challenging retrieval/ranking task on the test, as easily dismissed outliers (too visually dissimilar) are not present anymore.

Finally, we comment on the assessment in a binary classification scenario with same-vessel pair to be discriminated from different-vessel pairs. The comparison of a single image with all the available images of another vessel (averaging the scores) was considered. The obtained scores reveal a promising performance by all models, with F-1 scores between 0.932 and 0.943. For the model trained on the V1 dataset, these correspond to a high PD of 0.967 and a PFa of only 0.084 (at the optimal threshold of 0.55 on the image match probabilities in [0, 1], as selected on the validation set).

A histogram of similarity scores for nadir-nadir images showing how much they overlap (less overlap is shown in FIG. 6 for an image matcher model 122, according to an embodiment. A vertical black line is drawn to indicate the optimal similarity score used to threshold whether predictions are of match or non-match.

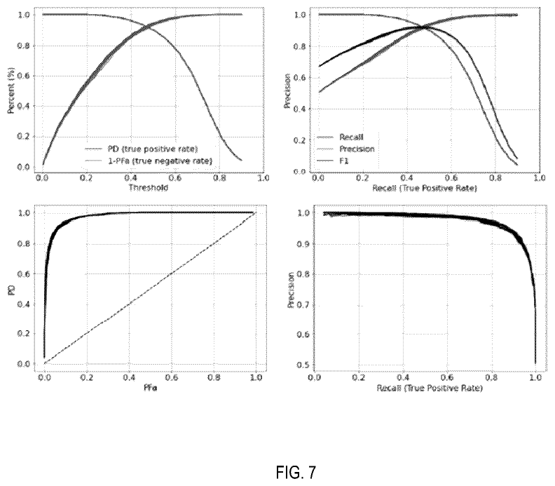

Referring to FIG. 7, in order to quantify model performance, precision, recall, and F1 score as functions of score threshold were plotted, and the score which gives the highest F1 score was chosen. Similarly, the detection probability and false alarm probability as functions of threshold were plotted, and the values at the optimal threshold chosen.

The optimal threshold is estimated to be 0.45, for which there is a detection probability of PD=0.94 and a false alarm rate of PFa=0.09. Because there are so many more possible negative pairs than positive pairs, the negative pairs were randomly selected 20 times, and these statistics were calculated multiple times to get a sense of the variability and found these probabilities to have a standard deviation of ~+/−0.01.

In some cases, match probabilities may be conditioned on vessel length classes (e.g., from a vessel length classifier trained to classify vessel length in a nadir image). In this case, the PD and PFa values are recalculated, conditioned on the vessel length classes of small, medium, large. FIGS. 6 and 7 above can be regenerated for small, medium, or large vessels, resulting in rates of PD=0.93, 0.92, 0.95, and PFa=0.10, 0.10, 0.07 for the small, medium, and large classes, respectively. This shows that the nadir-nadir image matcher does a bit better on large ships, but not much worse on small and medium ships.

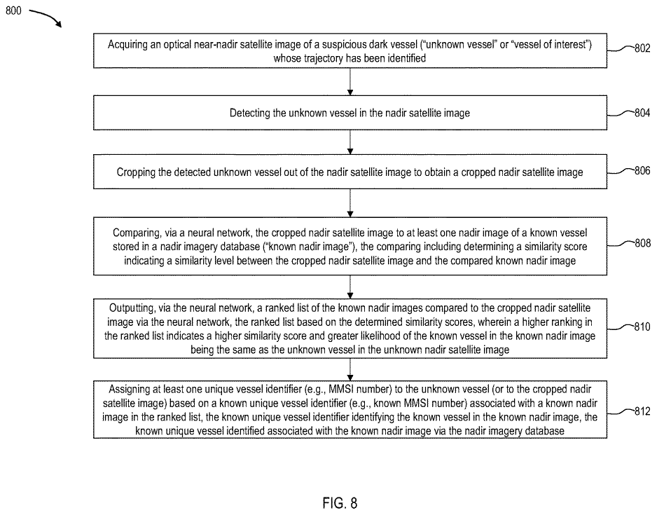

Referring now to FIG. 8, shown therein is a method 800 of object identification using unknown and known nadir optical satellite images, according to an embodiment. The method 800 may be encoded as computer-executable instructions and executed by one or more computing devices comprising one or more processors. In an embodiment the method 800 may be executed by the computer system 100 of FIG. 1.

At 802, the method 800 includes acquiring an optical near-nadir satellite image of a suspicious dark vessel (“unknown vessel” or “vessel of interest”) whose trajectory has been identified. The image may be referred to as an “unknown nadir image”.

At 804, the method 800 includes detecting the unknown vessel in the unknown nadir image.

At 806, the method 800 includes cropping the detected unknown vessel out of the unknown nadir image to obtain a cropped unknown nadir image.

In some embodiments, operations 802, 804, and 806 may not form part of method 800 and may have already been performed. For example, in some embodiments, the method 800 may start with an input of a cropped unknown nadir optical satellite image containing a detected vessel of interest.

At 808, the method 800 includes comparing, via a neural network, the cropped unknown nadir image to at least one known nadir image of a known vessel stored in a nadir imagery database. The comparing includes determining a similarity score indicating a similarity level between the cropped unknown nadir image and the compared known nadir image.

At 810, the method 800 includes outputting, via the neural network, a ranked list of the known nadir images that were compared to the cropped unknown nadir image via the neural network at 808. The ranked list is based on the determined similarity scores, wherein a higher ranking in the ranked list indicates a higher similarity score and greater likelihood of the known vessel in the known nadir image being the same as the unknown vessel in the unknown nadir image. In an embodiment, the ranked list may be saved in JSON or similar format and transferred to a visualization graphical user interface implemented at a user device.

At 812, the method 800 includes assigning at least one unique vessel identifier (e.g., MMSI number) to the unknown vessel (or to the cropped optical satellite image) based on a known unique vessel identifier (e.g., known MMSI number) associated with a known nadir image in the ranked list. The known unique vessel identifier identifies the known vessel in the known nadir image. The known unique vessel identifier is associated with the known nadir image via the nadir imagery database.

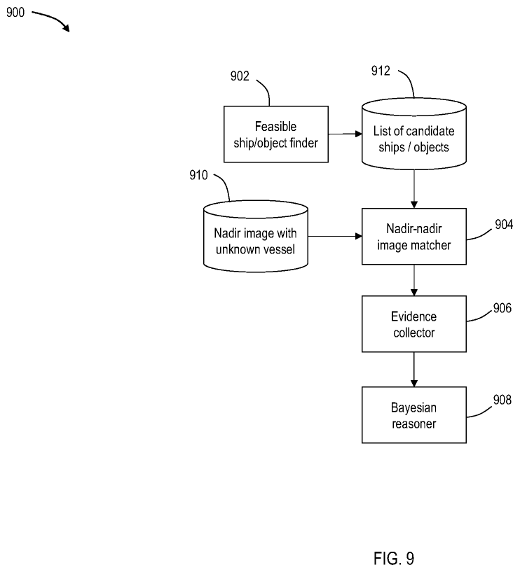

Referring now to FIG. 9, shown therein is a system 900 for vessel reidentification using multiple image source types including satellite imagery, according to an embodiment.

The system 900 includes a feasible ships finder module 902, a nadir-nadir image matcher 904, and evidence collector module 906, and a Bayesian reasoner module 908. The nadir-nadir image matcher 904 may include one or more components of system 100. The nadir-nadir image matcher 904 receives an unknown nadir image 910 of an unknown ship and a list of nadir images of candidate ships 912. The list of candidate ships 912 is determined by the feasible ship finder module 902. The nadir-nadir image matcher 904 receives an observed ship image 910 that was acquired by a high resolution optical satellite and a set of known candidate images 912 (or their feature vectors). In some cases, only the feature vectors of the candidate images may be provided to and used by the nadir-nadir image matcher in the comparison (i.e., to a feature vector of the unknown nadir image generated by the matcher 904). The known candidate images 912 come from a database of known nadir images and are selected by the feasible ship finder 902. The nadir-nadir image matcher 904 outputs the candidate list with similarity scores that are ordered (i.e., a list of candidate ships ordered by similarity score). The similarity scores may be converted into probabilities of matching the observed ship. The output of the nadir-nadir image matcher 904 including the ordered list of similarity scores is sent to the evidence collector 906 and eventually the Bayesian reasoner 908. For example, the nadir-nadir image matcher 904 may be an instance of the list of candidate ships 912 (or some subset thereof) ordered according to similarity score. Downstream the similarity score is converted into a probability of matching which can be used by the Bayesian reasoner 908. The Bayesian reasoner 908 may combine the matching probability with other evidence collected by the evidence collector 906, such as how well the observed ship's estimated length and width match with those in the candidate list. In some embodiments, similarity score outputs generated by the nadir-nadir image matcher 904 are converted into calibrated probabilities that can be combined with other probabilities or probability inputs by the Bayesian reasoner module 908.

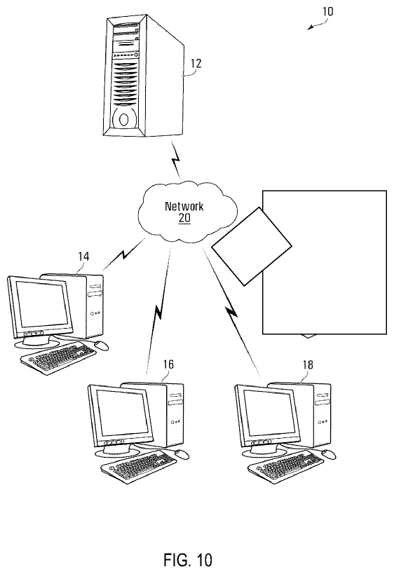

Referring now to FIG. 10, shown therein is a computer system for object identification using nadir-nadir image matching, according to an embodiment.

The system 10 includes a server platform 12 which communicates with a plurality of database server devices 14, a plurality of model training devices 16, and a plurality of user devices 18 via a network 20. The server platform 12 may be a purpose-built machine designed specifically for performing object identification (e.g., marine vessel identification) using nadir-nadir image matching, such as described herein.

The server platform 12, database server devices 14, model training devices 16, and user devices 18 may be a server computer, desktop computer, notebook computer, tablet, PDA, smartphone, or another computing device. The devices 12, 14, 16, 18 may include a connection with the network 20 such as a wired or wireless connection to the Internet. In some cases, the network 20 may include other types of computer or telecommunication networks. The devices 12, 14, 16, 18 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage or may be received from the Internet or other network 20. Input device may include any device for entering information into device 12, 14, 16, 18. For example, input device may be a keyboard, keypad, cursor-control device, touchscreen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 12, 14, 16, 18 may include multiple of any one or more of processors, applications, software modules, second storage devices, network connections, input devices, output devices, and display devices.

Although devices 12, 14, 16, 18 are described with various components, one skilled in the art will appreciate that the devices 12, 14, 16, 18 may in some cases contain fewer, additional or different components. In addition, although aspects of an implementation of the devices 12, 14, 16, 18 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18 and/or processor to perform a particular method.

In the description that follows, devices such as server platform 12, database server devices 14, model training devices 16, and user devices 18 are described performing certain acts. It will be appreciated that any one or more of these devices may perform an act automatically or in response to an interaction by a user of that device. That is, the user of the device may manipulate one or more input devices (e.g. a touchscreen, a mouse, or a button) causing the device to perform the described act. In many cases, this aspect may not be described below, but it will be understood.

As an example, it is described below that the devices 12, 14, 16, 18 may send information to the server platform 12. For example, a user using the user device 18 may manipulate one or more input devices (e.g. a mouse and a keyboard) to interact with a user interface displayed on a display of the user device 18. Generally, the device may receive a user interface from the network 20 (e.g. in the form of a webpage). Alternatively, or in addition, a user interface may be stored locally at a device (e.g. a cache of a webpage or a mobile application).

Server platform 12 may be configured to receive a plurality of information, from each of the plurality of database server devices 14, model training devices 16, and user devices 18. Generally, the information may comprise at least an identifier identifying the database server, model training device, or user. For example, the information may comprise one or more of a username, e-mail address, password, or social media handle.

In response to receiving information, the server platform 12 may store the information in storage database. The storage may correspond with secondary storage of the device 12, 14, 16, 18. Generally, the storage database may be any suitable storage device such as a hard disk drive, a solid state drive, a memory card, or a disk (e.g. CD, DVD, or Blu-ray etc.). Also, the storage database may be locally connected with server platform 12. In some cases, storage database may be located remotely from server platform 12 and accessible to server platform 12 across a network for example. In some cases, storage database may comprise one or more storage devices located at a networked cloud storage provider.

The database server device 14 may be associated with a database server account. Similarly, the model training device 16 may be associated with a model training account, and the user device 18 may be associated with a user account. Any suitable mechanism for associating a device with an account is expressly contemplated. In some cases, a device may be associated with an account by sending credentials (e.g. a cookie, login, or password etc.) to the server platform 12. The server platform 12 may verify the credentials (e.g. determine that the received password matches a password associated with the account). If a device is associated with an account, the server platform 12 may consider further acts by that device to be associated with that account.

While the above description provides examples of one or more apparatus, methods, or systems, it will be appreciated that other apparatus, methods, or systems may be within the scope of the claims as interpreted by one of skill in the art.

1. A computer system for computer vision-based maritime surveillance and identification of unknown vessels, the system comprising:
at least one data storage device storing:
a database of known optical nadir satellite images each containing a known candidate vessel, each known candidate vessel having a known unique vessel identifier associated therewith that is stored in the database and which identifies the known candidate vessel; and
an unknown optical nadir satellite image containing an unknown vessel; and
at least one processor configured to execute a nadir-nadir image matcher, the nadir-nadir image matcher configured to:
compare, via a neural network, the unknown nadir image to a plurality of known nadir images in the database, the comparing including determining a similarity score indicating a similarity level between the unknown nadir image and a respective known nadir image;
output, via the neural network, a ranked list of the known nadir images, the ranked list based on the determined similarity scores, wherein a higher ranking in the ranked list indicates a higher similarity score and greater likelihood of the known vessel in the known nadir image being the same as the unknown vessel in the unknown nadir image; and
assign a known unique vessel identifier to the unknown nadir image based on the ranked list.

2. The system of claim 1, wherein the nadir-nadir image matcher is further configured to store the unknown nadir image as a new known nadir image in the database, the database including the assigned known vessel identifier in association with the new unknown nadir image.

3. The system of claim 1, wherein the at least one processor is further configured to execute a user interface module configured to display a graphical user interface including a graphical representation of the ranked list and receive a user input selecting a known nadir image from the ranked list, and wherein the assigning includes assigning, in response to the user input, the known vessel identifier associated with the selected known nadir image to the unknown nadir image.

4. The system of claim 1, wherein the graphical representation of the ranked list includes, for each known nadir image in the ranked list, a visual representation of the known nadir image.

5. The system of claim 1, wherein assigning the known unique vessel identifier to the unknown nadir image is performed automatically without user input by the nadir-nadir image matcher based on a similarity score of a known nadir image associated with the known unique vessel identifier exceeding a predetermined threshold similarity score.

6. The system of claim 1, wherein the at least one processor is further configured to execute a user interface module configured to: display a graphical user interface including the assignment of the known vessel identifier to the unknown nadir image and a visual representation the known nadir image associated with the known unique vessel identifier and the unknown nadir image; and receive a user input confirming or rejecting the assignment.

7. The system of claim 1, wherein the unique vessel identifier is a maritime mobile service identify number.

8. The system of claim 1, wherein the neural network is a Siamese neural network configured to receive a plurality of nadir image pairs as input, each nadir image pair including the unknown nadir image and a known nadir image from the database.

9. The system of claim 1, wherein a trajectory comprising a time and location of the unknown vessel is encoded with the unknown nadir image and used by the at least one processor to determine the plurality of known nadir images to which the unknown nadir image is compared by the nadir-nadir image matcher.

10. The system of claim 1, wherein the plurality of known nadir images represents a list of candidate vessels identified by a feasible vessel finder module based on a trajectory of unknown vessel in the unknown nadir image.

11. The system of claim 10, wherein the at least one processor is further configured to execute the feasible vessel finder module to obtain the list of candidate vessels.

12. The system of claim 1, wherein the unknown nadir image has only one time and location encoded therewith that is used to determine the plurality of known nadir images for comparison with the unknown nadir image via a trajectory analysis.

13. The system of claim 9, wherein the trajectory is obtained from automatic identification system (AIS) data.

14. A method of computer vision-based maritime surveillance and identification of unknown vessels, the method comprising:
comparing, via a neural network, a cropped unknown nadir image to at least one known nadir image of a known vessel stored in a nadir imagery database, the comparing including determining a similarity score indicating a similarity level between the cropped unknown nadir image and the compared known nadir image, the known nadir image containing a known candidate vessel having a known unique vessel identifier associated therewith that is stored in association with the known nadir image and which identifies the known candidate vessel, outputting, via the neural network, a ranked list of the known nadir images that were compared to the cropped unknown nadir image, the ranked list based on the determined similarity scores, wherein a higher ranking in the ranked list indicates a higher similarity score and greater likelihood of the known vessel in the known nadir image being the same as the unknown vessel in the unknown nadir image; and
assigning at least one unique vessel identifier to the cropped unknown nadir image based on the ranked list.

15. The method of claim 14, further comprising identifying a trajectory of the unknown vessel in the unknown nadir image and using the trajectory to identify a subset of the known nadir images in the nadir imagery database for comparison to the unknown nadir image.
